(19) United States
(12) Patent Application Publication
(10) Pub. No.: US 2021/0002939 A1
(43) Pub. Date: Jan. 7, 2021

(54) REEL DAMPER

(71) Applicant: ILLINOIS TOOL WORKS INC., Glenview, IL (US)

(72) Inventors: Daniel Lindsey, Tinley Park, IL (US); Steven L. Bivens, Kankakee, IL (US)

(21) Appl. No.: 16/916,231

(22) Filed: Jun. 30, 2020

Related U.S. Application Data
(60) Provisional application No. 62/869,732, filed on Jul. 2, 2019.

(51) Int. Cl. E05F 3/14; F16F 1/12; B62D 25/12

(52) U.S. Cl. CPC E05F 3/14; F16F 1/12; E05Y 2900/538; F16F 2236/08; B62D 25/12

(57) ABSTRACT

A reel damper includes a base, a cap, a ring gear, a torsion spring, and a sun gear. The cap is secured to the base, and the ring gear is rotatably engaged with the base. The torsion spring is engaged with the base and the ring gear. The sun gear is disposed in and meshed with the ring gear.

### CROSS REFERENCE TO RELATED APPLICATIONS

This application is based on, claims priority to, and incorporates herein by reference in its entirety U.S. Provisional Application No. 62/869,732, filed on Jul. 2, 2019, and entitled “REEL DAMPER”.

### BACKGROUND OF THE INVENTION

### 1. Field of the Invention

Embodiments of the present disclosure generally relate to vehicle hatch components, and, more particularly, to a reel damper.

### 2. Description of the Background of the Invention

In recent years, dampers have been developed to control movements of vehicle hatches (e.g., glove boxes, consoles, storage compartments, etc.). For example, a damper may be connected to a door and a jamb of a vehicle hatch to control pivoting of the door relative to the jamb. These dampers slow the pivoting of the door relative to the jamb, aid in returning the door to a closed position, and generally improve a driver's experience when using a vehicle hatch.

Certain known dampers use a string wound about a reel and a spiral spring (e.g., a clock spring) engaged with the reel to control pivoting of a vehicle hatch door relative to a jamb of the vehicle hatch.

However, the spiral springs used in the known dampers are often high in cost. Therefore, a need exists for a damper that controls vehicle hatch movement using lower cost components.

### SUMMARY OF THE INVENTION

In one aspect of the present disclosure, an example reel damper includes a base, a cap, a ring gear, a torsion spring, and a sun gear. The cap is secured to the base, and the ring gear is rotatably engaged with the base. The torsion spring is engaged with the base and the ring gear. The sun gear is disposed in and meshed with the ring gear.

In some embodiments, the reel damper comprises a spool gear attached to the sun gear and is rotatably engaged with the cap. The spool gear is configured to retain a string around the spool gear. In other embodiments, the reel damper includes at least one damper assembly. In further embodiments, the torsion spring comprises a coil portion that is disposed in the base. The torsion spring further comprises a first leg and a second leg that extend from the coil portion. The first leg is substantially straight and the second leg comprises an angled portion. In other embodiments, the torsion spring is pre-loaded during assembly. In some embodiments, the ring gear is eccentrically attached to the base of the reel damper.

In another aspect of the present disclosure, an example reel damper includes a base, a cap, a ring gear, a torsion spring, a sun gear, and a spool gear. The cap is attached to the base. The ring gear is rotatably engaged with the base. The torsion spring is engaged with the base and the ring gear. The sun gear is disposed in and meshed with the ring gear. The spool gear is attached to the sun gear and rotatably engaged with the cap. The spool gear comprises a reel track that extends circumferentially around the spool gear.

In some embodiments, the spool gear is meshed with at least one damper assembly. The at least one damper assembly comprises a set of ratchet teeth that extend circumferentially around the at least one damper assembly. The set of ratchet teeth selectively engage a set of pawl teeth on the base. In other embodiments, the torsion spring comprises a coil portion. The torsion spring further comprises a first leg and a second leg that extend from the coil portion. The first leg of the torsion spring is positioned within a spring retainer of the ring gear. In further embodiments, the ring gear comprises gear teeth that only partially extend around a circumference of the ring gear.

In yet another aspect of the present disclosure, an example reel damper includes a base, a cap, a ring gear, a torsion spring, a sun gear, and a spool gear. The cap is attached to the base. The ring gear is rotatably engaged with the base. The torsion spring is engaged with the base and the ring gear. The sun gear is disposed in and meshed with the ring gear. The spool gear is attached to the sun gear and rotatably engaged with the cap. The spool gear comprises a set of gear teeth that mesh with at least one damper assembly. The spool gear further comprises a reel track that extends circumferentially around the spool gear. The ring gear, the torsion spring, the sun gear, and the spool gear are positioned in an interior portion inside the cap and the base.

In some embodiments, the rotation of the spool gear drives rotation of the ring gear. In other embodiments, the torsion spring is configured to rotate the ring gear. In further embodiments, the torsion spring comprises a coil portion. The torsion spring further comprises a first leg and a second leg that extend from the coil portion.

### BRIEF DESCRIPTION OF THE DRAWINGS

The invention will be better understood and features, aspects, and advantages other than those set forth above will become apparent when consideration is given to the following detailed description thereof. Such detailed description makes reference to the following drawings.

FIG. 1 is an isometric view of a reel damper according to an embodiment of the present disclosure;

FIG. 2 is a top view of the reel damper of FIG. 1;

FIG. 3 is a first side view of the reel damper of FIGS. 1 and 2;

FIG. 4 is second side view of the reel damper of FIGS. 1-3;

FIG. 5 is third side view of the reel damper of FIGS. 1-4;

FIG. 6 is fourth side view of the reel damper of FIGS. 1-5;

FIG. 7 is bottom view of the reel damper of FIGS. 1-6;

FIG. 8 is an exploded view of the reel damper of FIGS. 1-7;

FIG. 9 is a cross-sectional view of the reel damper of FIGS. 1-8 taken along line 9-9 of FIG. 2;

FIG. 10 is a cross-sectional view of the reel damper of FIGS. 1-9 taken along line 10-10 of FIG. 6;

FIG. 11 is an isometric view of a cap of the reel damper of FIGS. 1-10;

FIG. 12 is an isometric view of a base of the reel damper of FIGS. 1-10;

FIG. 13 is a top view of the base of FIG. 12;

FIG. 14 is an isometric view of a gear assembly including a spool gear and a sun gear of the reel damper of FIGS. 1-10;

FIG. 15 is another isometric view of the gear assembly of FIG. 14;

FIG. 16 is an isometric view of a damper assembly of the reel damper of FIGS. 1-10;

FIG. 17 is a top view of the damper assembly of FIG. 16;

FIG. 18 is an isometric cross-sectional view of the damper assembly of FIGS. 16 and 17 taken along line 18-18 of FIG. 17;

FIG. 19 is an isometric view of a ring gear of the reel damper of FIGS. 1-10;

FIG. 20 is another isometric view of the ring gear of FIG. 19;

FIG. 21 is a bottom view of the ring gear of FIGS. 19 and 20;

FIG. 22 is an isometric view of a torsion spring of the reel damper of FIGS. 1-10;

FIG. 23 is an isometric view of the reel damper of FIGS. 1-10 with the cap of FIG. 11 removed;

FIG. 24 is an isometric view of the reel damper of FIGS. 1-10 with the cap of FIG. 11 removed and the spool gear of FIGS. 14 and 15 shown in phantom;

FIG. 25 is an isometric view of the reel damper of FIGS. 1-10 with the cap of FIG. 11 and the spool gear of FIGS. 14 and 15 removed;

FIG. 26 is a top view of the reel damper of FIGS. 1-10 with the cap of FIG. 11 and the spool gear of FIGS. 14 and 15 removed;

FIG. 27 is an isometric view of the reel damper of FIGS. 1-10 with the base of FIGS. 12 and 13 removed;

FIG. 28 is a bottom view of the reel damper of FIGS. 1-10 with the base of FIGS. 12 and 13 removed;

FIG. 29 is a bottom view of the reel damper of FIGS. 1-10 with the base of FIGS. 12 and 13 removed and the ring gear of FIGS. 19-21 shown in phantom; and

FIG. 30 is a bottom view of the reel damper of FIGS. 1-10 with the base of FIGS. 12 and 13 shown in phantom.

Before the embodiments of the disclosure are explained in detail, it is to be understood that the disclosure is not limited in its application to the details of construction and the arrangement of the components set forth in the following description or illustrated in the drawings. The disclosure is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF THE DRAWINGS

Embodiments of the present disclosure provide a reel damper that controls vehicle hatch movement using lower cost components. Specifically, the reel damper uses a torsion spring that drives a ring gear, which then drives a gear assembly. As a result of the torsion spring, the cost of the reel damper is substantially lowered.

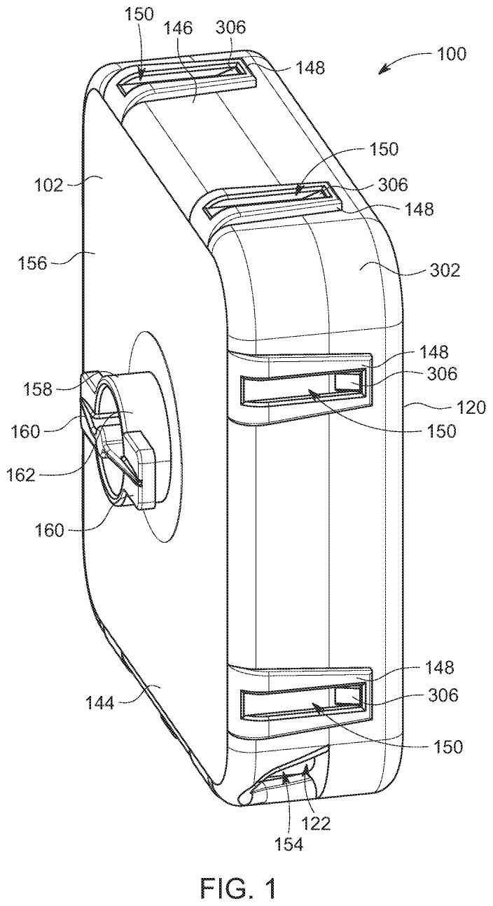

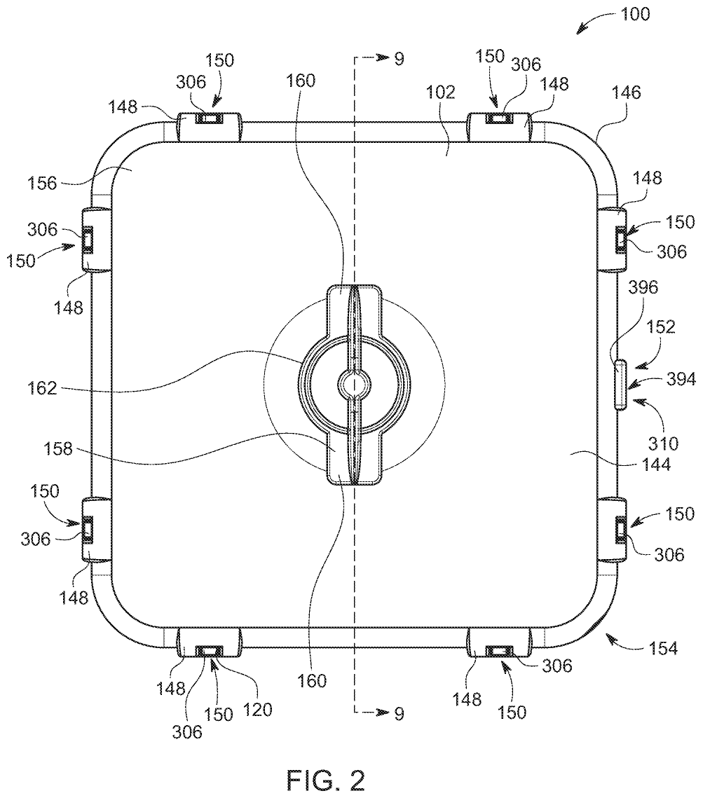

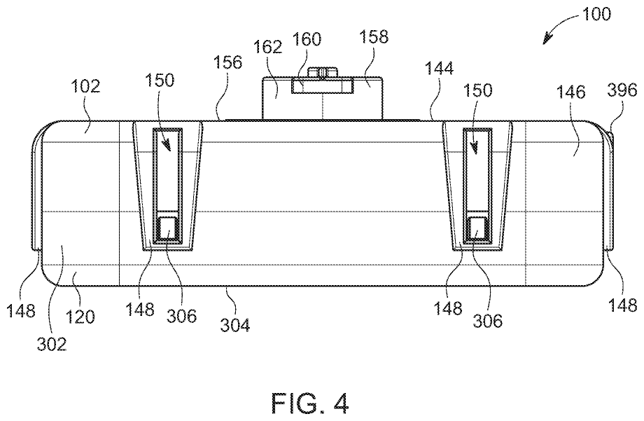

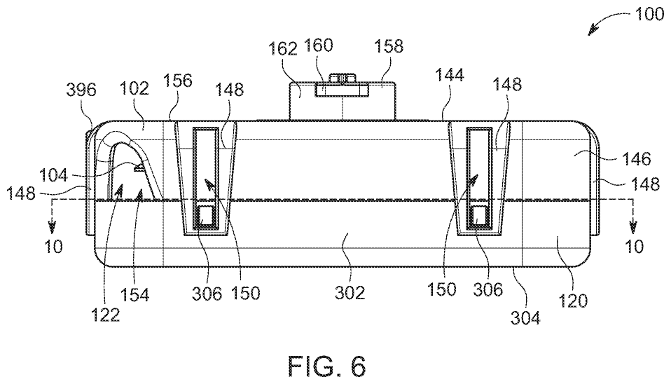

FIGS. 1-10 illustrate a reel damper 100 in accordance with the present disclosure. With reference to FIGS. 1-10 various views of the reel damper 100 are shown. The reel damper 100 is provided to control movements of a variety of vehicle hatches (e.g., glove boxes, consoles, storage compartments, etc.). In preferred embodiments, the reel damper 100 may be used for damping a glove box door (not shown). It is contemplated that the reel damper 100 may be used in any portion of the vehicle. In alternative embodiments, the reel damper 100 may not be used in a vehicle. Instead, the reel damper 100 may be used to control movements in various pivotable or moveable systems. In some embodiments, the reel damper 100 is molded of plastic. It is contemplated that the reel damper 100 can be formed by any conventional method.

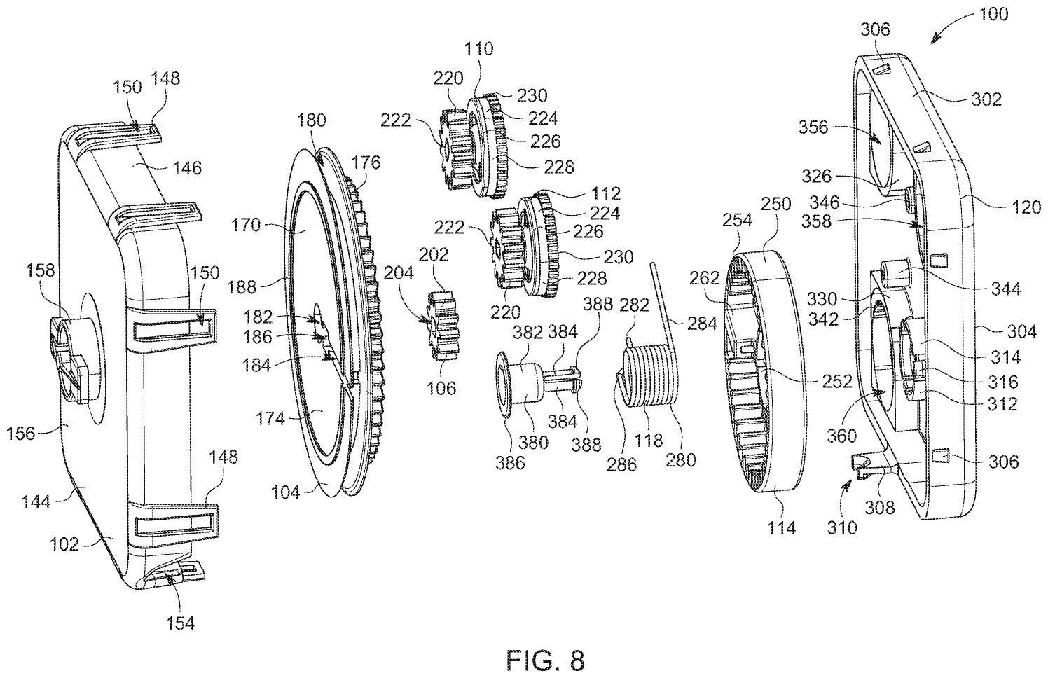

With reference to FIG. 8, the reel damper 100 includes a cap 102, a spool gear 104, a sun gear 106, a first damper assembly 110, a second damper assembly 112, a ring gear 114, a torsion spring 118, and a base 120. As illustrated in FIG. 8, the spool gear 104, the sun gear 106, the first and second damper assemblies 110, 112, the ring gear 114, and the torsion spring 118 are positioned in an interior portion 122 inside the cap 102 and the base 120. As such, the cap 102 and the base 120 are secured or attached to each other to form the interior portion 122 of the reel damper 100. In preferred embodiments, the reel damper 100 also includes a string (not shown) wound about and retained by the spool gear 104. In some examples, the reel damper 100 may also include a third damper assembly (not shown). Further, in alternative embodiments, the reel damper 100 may only include the first damper assembly 110.

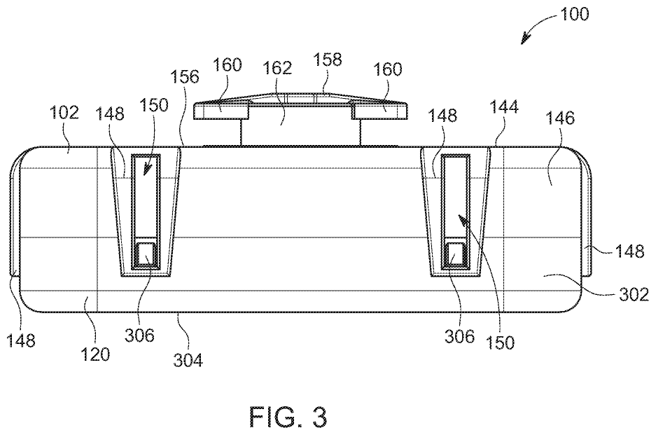

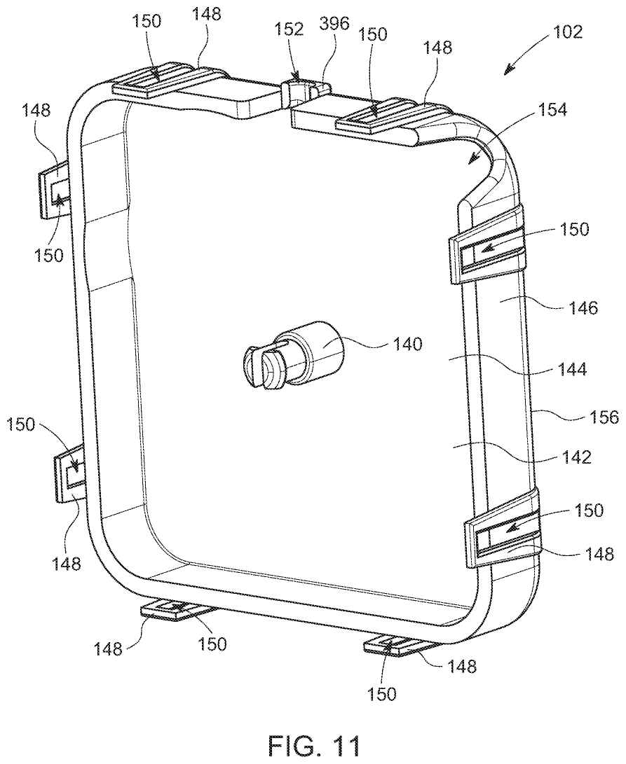

With reference to FIG. 11, an isometric view of the cap 102 is shown. The cap 102 includes an axle post 140 extending from a bottom side 142 of a first end wall 144. Further, the cap 102 includes a first perimeter wall 146 that extends around the perimeter of the first end wall 144. As illustrated in FIG. 11, the cap 102 includes a plurality of clips 148 that extend from the first perimeter wall 146. Each of the clips 148 includes a slot 150 extending therethrough. As will be discussed in further detail herein, the slots 150 cooperate with the base 120 to close the reel damper 100 (see FIGS. 3-6). In preferred embodiments, the first perimeter wall 146 includes a first string channel 152 that extends therethrough. Furthermore, the first perimeter wall 146 also includes a channel 154 that extends through the first perimeter wall 146. In some embodiments, the first string channel 152 may be the only channel in the first perimeter wall 146. In alternative embodiments, the first perimeter wall 146 may include more or fewer clips 148 than illustrated.

With reference to FIGS. 1-6, a top side 156 of the first end wall 144 is shown. As illustrated in FIGS. 1-6, the top side 156 of the first end wall 144 includes an anchor 158 extending therefrom. The anchor 158 includes two arms 160 extending from a cylindrical base 162. In alternative embodiments, the anchor 158 may include more than two arms 160. In preferred embodiments, the anchor 158 may attach the reel damper 100 to a component of a vehicle.

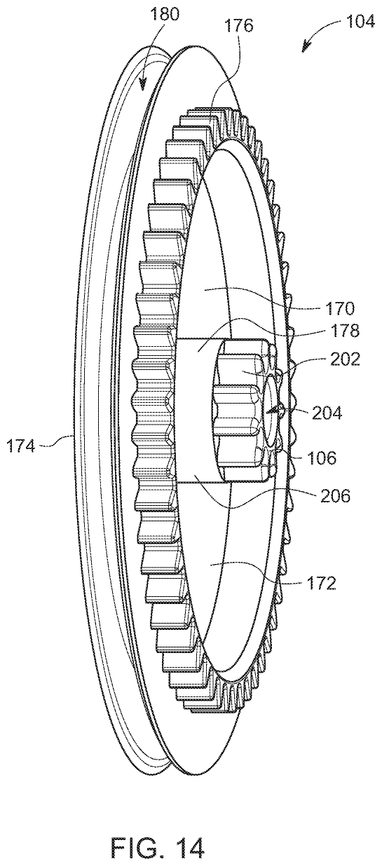

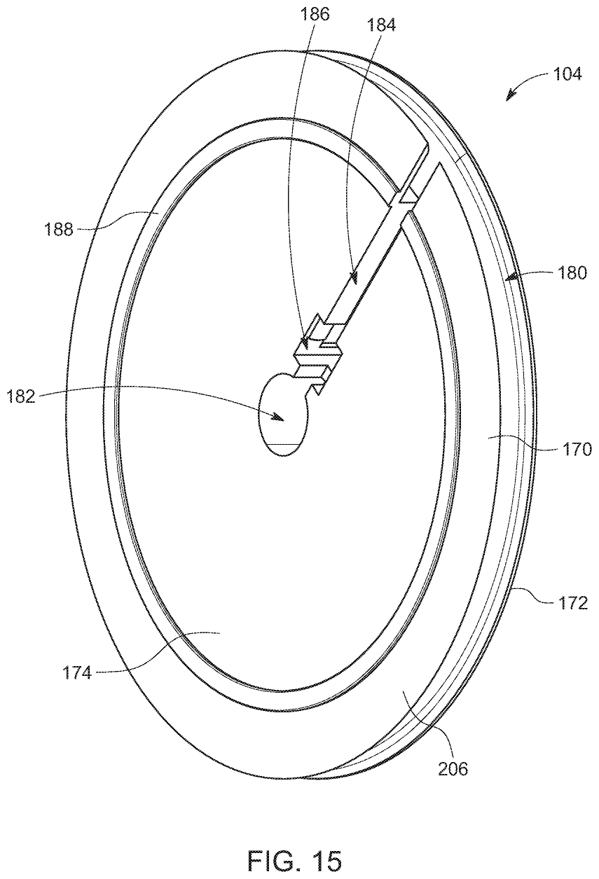

With reference to FIGS. 14 and 15, a bottom isometric view and a top isometric view of the spool gear 104 are shown, respectively. As illustrated in FIG. 14, the spool gear 104 includes a body 170 that comprises a bottom end 172 and a top end 174. A first set of gear teeth 176 are attached to the bottom end 172 of the spool gear 104. Additionally, the first set of gear teeth 176 extend around a protrusion 178 formed in the middle of the bottom end 172 of the spool gear 104. The protrusion 178 defines a generally cylindrical shape; however, the protrusion 178 may comprise any type of shape. Further, the spool gear 104 comprises a reel track 180 that extends circumferentially around the spool gear 104. In preferred embodiments, the string (not shown) is wound around the spool gear 104 inside the reel track 180. Therefore, the reel track 180 of the spool gear 104 is configured to retain the string (not shown) throughout operation of the reel damper 100. As will be discussed in further detail herein, the spool gear 104 is attached to the sun gear 106.

With reference to FIG. 15, the top end 174 of the spool gear 104 comprises an axle well 182 that extends through the body 170 of the spool gear 104. Further, the spool gear 104 defines a string slot 184 in the body 170 that extends from the axle well 182 to the reel track 180. In this embodiment, the string slot 184 extends through the body 170 of the spool gear 104, and the string slot 184 comprises a square slot 186 that is configured to secure one end of the string (not shown) to the spool gear 104. The top end 174 of the spool gear 104 further comprises a circular rib 188 that extends in a circular pattern around the axle well 182. As discussed above, the spool gear 104 is configured to retain the string (not shown) around the spool gear 104.

With reference again to FIG. 14, the sun gear 106 is shown coupled to the spool gear 104. As illustrated in FIG. 14, the sun gear 106 includes a second set of gear teeth 202 and defines a first opening 204. The first opening 204 is aligned with the axle well 182 of the spool gear 104 (see FIG. 15), and the sun gear 106 is coupled to the protrusion 178 of the spool gear 104. In some embodiments, the sun gear 106 may be formed as an integral component with the spool gear 104. In alternative embodiments, the sun gear 106 can be formed separately from the spool gear 104 and attached thereafter. In further embodiments, the sun gear 106 may be removably coupled to the spool gear 104. When the spool gear 104 is joined to the sun gear 106, they may be collectively referred to as a gear assembly 206.

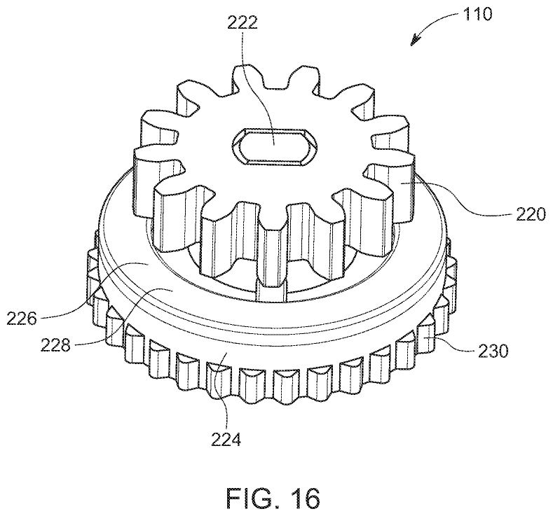

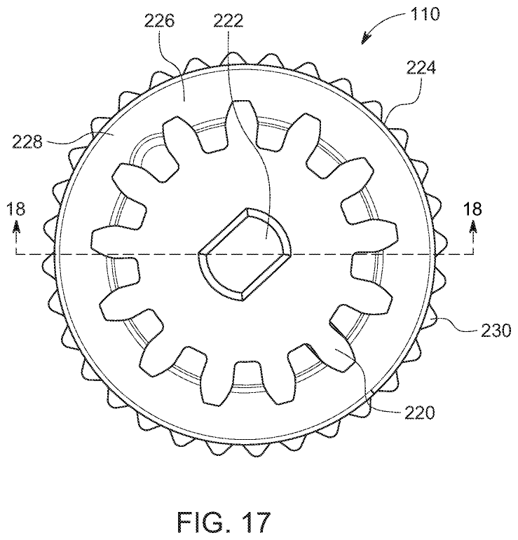

With reference to FIGS. 16 and 17, an isometric view and a top view of the first damper assembly 110 are shown, respectively. As noted herein, the first damper assembly 110 is substantially identical to the second damper assembly 112 (see FIG. 8). Thus, all components described with respect to the first damper assembly 110 are included in the second damper assembly 112. As illustrated in FIGS. 16 and 17, the first damper assembly 110 includes a pinion 220 rotatably attached to a rotor 222. Additionally, the first damper assembly 110 comprises a pot 224 and a cover 226 that is positioned over the pot 224 of the first damper assembly 110. As further noted herein, the pot 224 and the cover 226 of the first damper assembly 110 define a base 228 of the first damper assembly 110. In preferred embodiments, the pot 224 includes a set of ratchet teeth 230 that extend circumferentially around the first damper assembly 110.

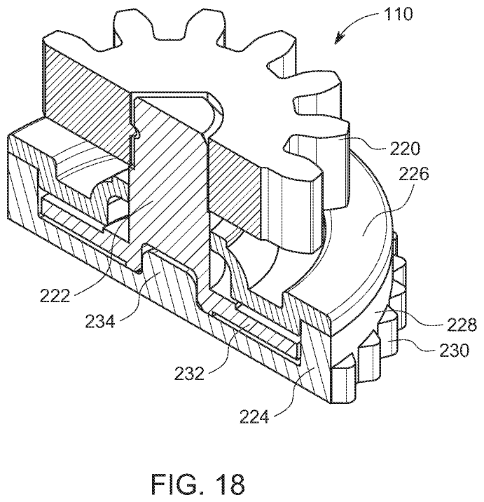

With reference to FIG. 18, a cross-sectional view of the first damper assembly 110 is shown. As illustrated in FIG. 18, the rotor 222 is attached to the first damper assembly 110 by the cover 226 and the pot 224. In particular, a bottom portion 232 of the rotor 222 is secured onto a rod 234 that extends from the pot 224. Further, the cover 226 is placed over the pot 224 to secure the bottom portion 232 of the rotor 222 therebetween. In other embodiments, the first damper assembly 110 may comprise any type of conventional damping element. In one example, the damping element used is of the type disclosed in U.S. Pat. No. 7,152,718, which is incorporated herein by reference in its entirety. As noted herein, the first and second damper assemblies 110, 112 can include different types of silicon fluid disposed therein. For example, the first and second damper assemblies 110, 112 can be filled with fluid comprising different viscosities to change the damping resistance of the first and second damper assemblies 110, 112.

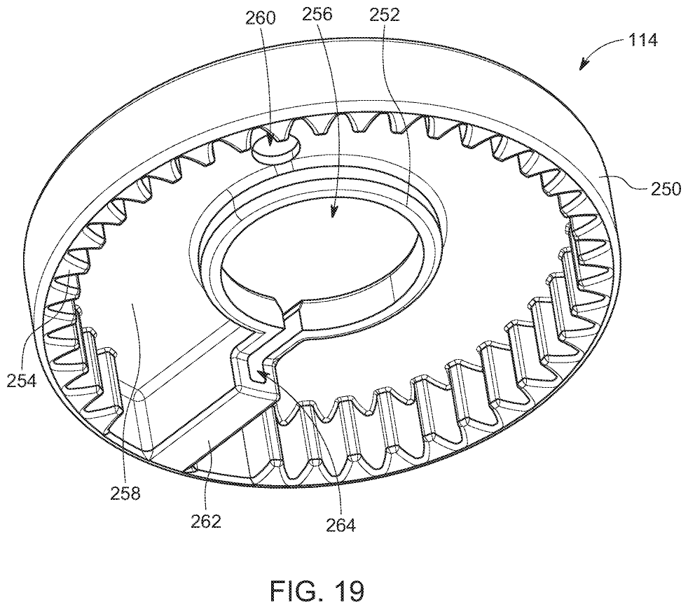

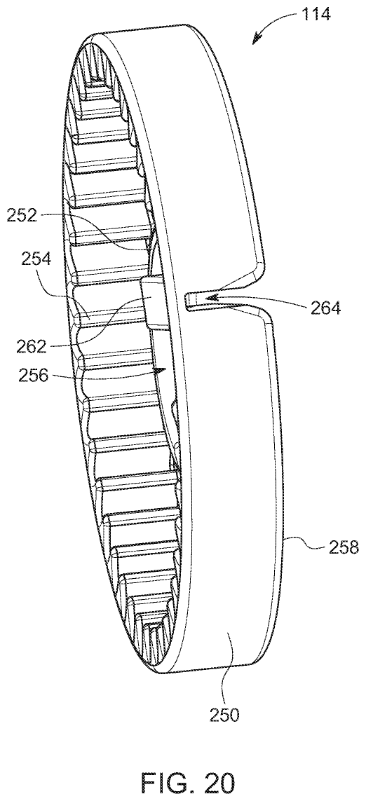

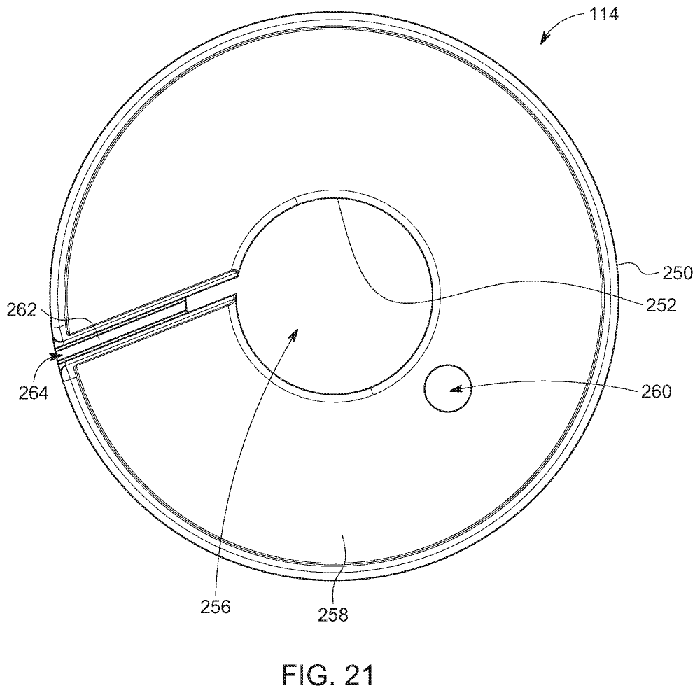

With reference to FIGS. 19-21, various views of the ring gear 114 are shown. As illustrated in FIGS. 19 and 20, the ring gear 114 includes an outer circumferential wall 250 and an inner circumferential wall 252. The outer circumferential wall 250 of the ring gear 114 comprises a third set of gear teeth 254 that extend inwardly toward the inner circumferential wall 252. As noted herein, the third set of gear teeth 254 only partially extend around the circumference of the outer circumferential wall 250 (see FIG. 19). Additionally, the inner circumferential wall 252 defines an axle opening 256 that extends through the ring gear 114. As illustrated in FIG. 19, the outer circumferential wall 250 is connected with the inner circumferential wall 252 by a second end wall 258 that extends therebetween. The second end wall 258 is generally planar and defines a first alignment opening 260. Further, the inner circumferential wall 252 is connected with a spring retainer 262 that extends from the inner circumferential wall 252 to the outer circumferential wall 250. The spring retainer 262 defines a spring channel 264 therebetween. As will become more apparent upon further discussion herein, the spring retainer 262 secures a portion of the torsion spring 118. In some embodiments, the spring retainer 262 may include a lip (not shown) therein.

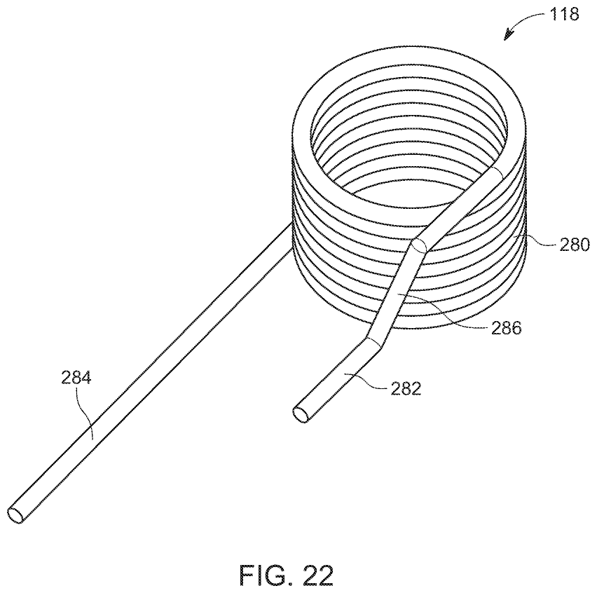

With reference to FIG. 22, an isometric view of the torsion spring 118 is shown. As illustrated in FIG. 22, the torsion spring 118 includes a coil portion 280, a first leg 282 extending from the coil portion 280, and a second leg 284 also extending from the coil portion 280. The second leg 284 of the torsion spring 118 extends substantially straight while the first leg 282 of the torsion spring 118 comprises an angled portion 286. In alternative embodiments, the first leg 282 of the torsion spring 118 may be straight and may not comprise the angled portion 286. As further illustrated in FIG. 22, the first leg 282 of the torsion spring 118 is shorter than the second leg 284 of the torsion spring 118. In other embodiments, the first leg 282 of the torsion spring 118 may be longer or the same length as the second leg 284 of the torsion spring 118. It is contemplated that the reel damper 100 may comprise any type of torsion spring 118 therein.

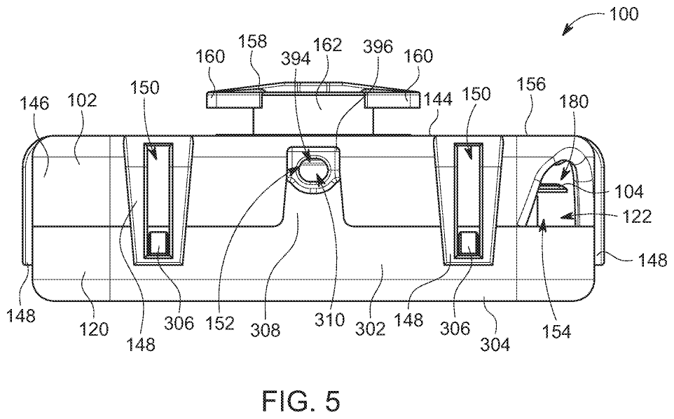

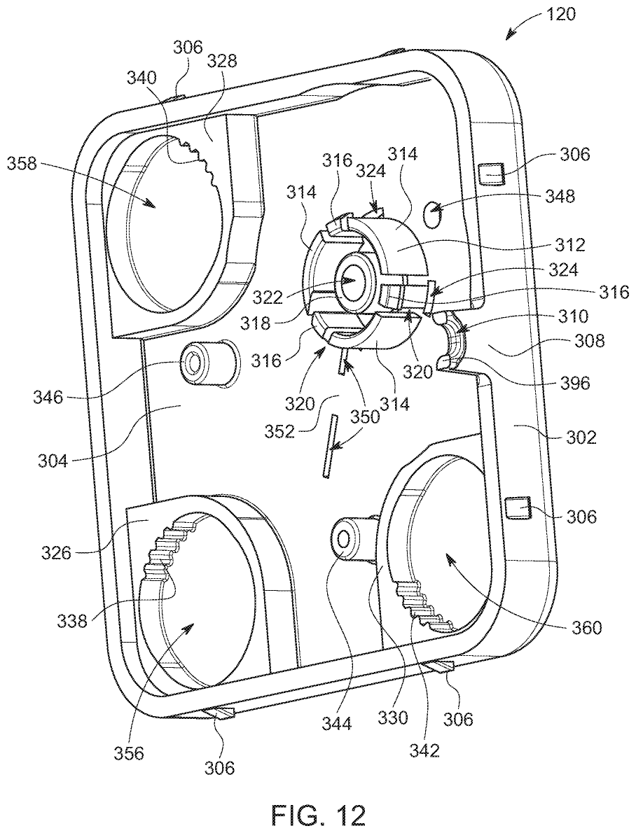

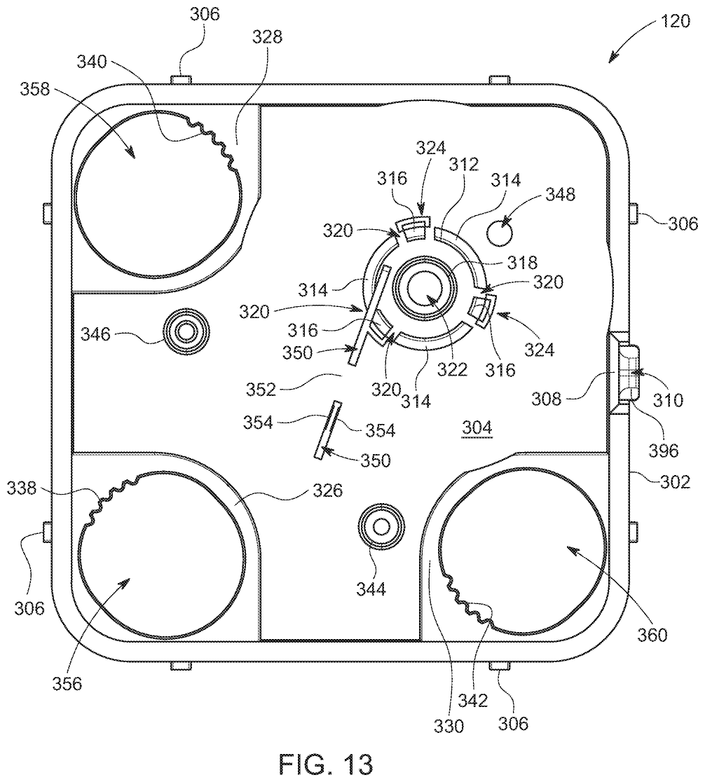

With reference to FIGS. 12 and 13, an isometric view and a top view of the base 120 are shown, respectively. As illustrated in FIGS. 12 and 13, the base 120 includes a second perimeter wall 302 that surrounds a third end wall 304. The second perimeter wall 302 comprises a plurality of tabs 306 that extend outwardly from the reel damper 100. Further, the second perimeter wall 302 comprises a finger 308 that extends upwardly from the second perimeter wall 302. The finger 308 defines a second string channel 310 that is configured to align with the first string channel 152 (see FIG. 5). Furthermore, the base 120 includes an axle hub 312 that extends upwardly from the third end wall 304. The axle hub 312 comprises a plurality of arched walls 314 and a plurality of hooks 316 that alternate around a first support post 318 that extends from the third end wall 304. As illustrated in FIG. 13, a gap 320 exists between each of the plurality of arched walls 314 and the plurality of hooks 316. In the present embodiments, each of the plurality of hooks 316 is positioned adjacent to an aperture 324 that extends through the third end wall 304. As a result of the apertures 324, the plurality of hooks 316 are configured to deflect inwardly and outwardly. In preferred embodiments, the first support post 318 comprises a passage 322 that extends through the base 120 (see FIG. 13).

With reference to FIG. 12, the base 120 of the reel damper 100 includes a first retaining wall 326, a second retaining wall 328, and a third retaining wall 330. The first, second, and third retaining walls 326, 328, 330 are located at corner portions of the base 120 and are attached to the second perimeter wall 302. Further, the first retaining wall 326 comprises a first set of pawl teeth 338, the second retaining wall 328 comprises a second set of pawl teeth 340, and the third retaining wall 330 comprises a third set of pawl teeth 342. In preferred embodiments, the base 120 further includes a second support post 344 and a third support post 346 that extend upwardly from the third end wall 304. The second support post 344 and the third support post 346 are spaced apart from each other and, in alternative embodiments, may be positioned in different portions of the base 120. In other embodiments, the base 120 may not include the first support post 318, the second support post 344, and/or the third support post 346.

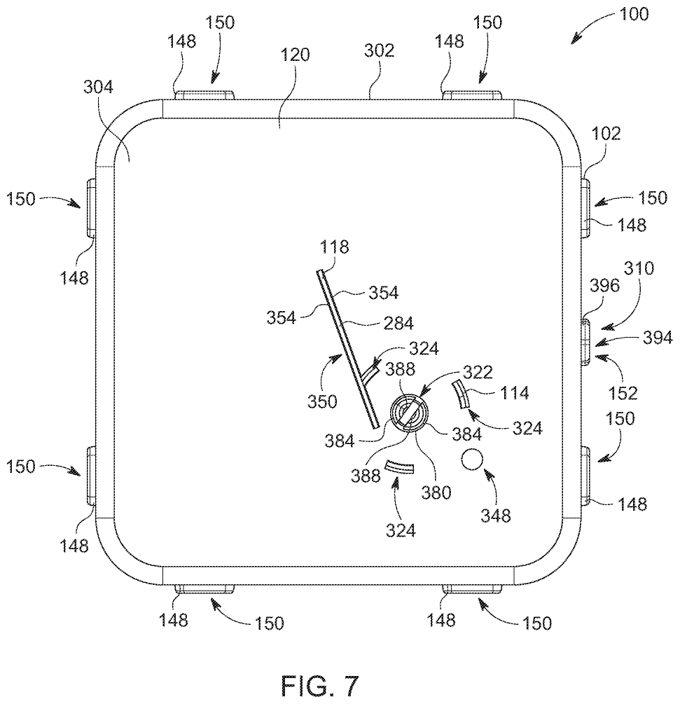

With reference still to FIG. 12, the third end wall 304 defines a second alignment opening 348 that extends through the base 120. Further, the third end wall 304 defines a spring opening 350 that extends through the third end wall 304. As illustrated in FIG. 13, the third end wall 304 comprises a bridge 352 that extends through the spring opening 350 such that the spring opening 350 is broken into two components. In preferred embodiments, the bridge 352 is generally flush with a surface of the third end wall 304 (see FIG. 13), and the bridge 352 does not comprise the same thickness as the third end wall 304. As further illustrated in FIG. 13, the third end wall 304 further comprises ribs 354 that extend into the spring opening 350. As will become more apparent upon further discussion herein, the second leg 284 of the torsion spring 118 is configured to be held in the spring opening 350 between the bridge 352 and the ribs 354 (see FIG. 7). In alternative embodiments, the third end wall 304 may comprise a spring stop instead of the spring opening 350. In further embodiments, the base 120 may include a plurality of bearings thereon.

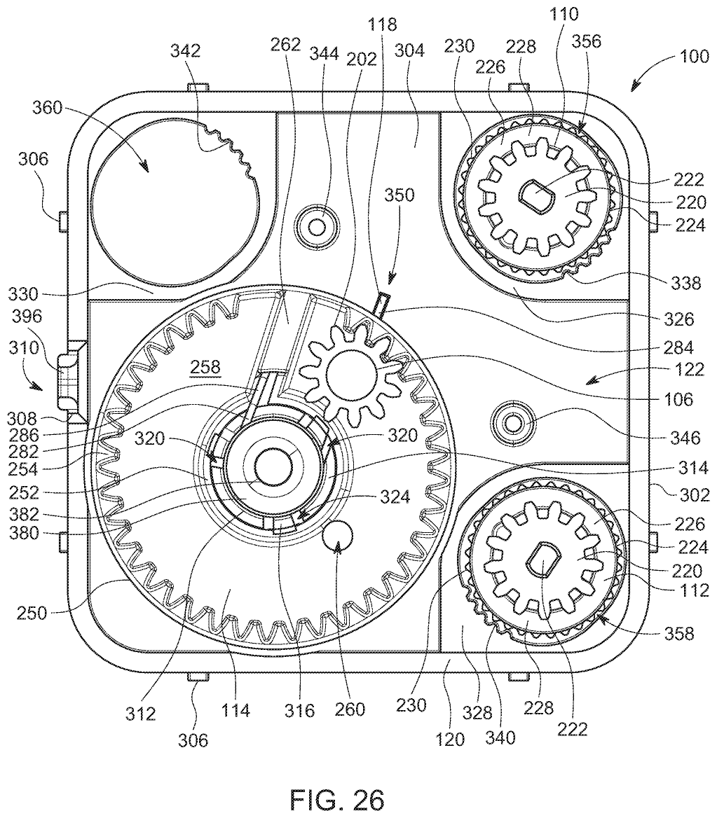

With reference to FIG. 12, the first retaining wall 326 and the second perimeter wall 302 define a first damper well 356. Further, the second retaining wall 328 and the second perimeter wall 302 define a second damper well 358. Additionally, the third retaining wall 330 and the second perimeter wall 302 define a third damper well 360. In preferred embodiments, the first damper assembly 110 is positioned within the first damper well 356 and the second damper assembly 112 is positioned within the second damper well 358 (see FIG. 26). In alternative embodiments, a third damper assembly may be positioned within the third damper well 360. It is contemplated that the first and second damper assemblies 110, 112 may be placed in any of the damper wells 356, 358, 360.

With reference back to FIG. 8, a support 380 is shown aligned with the torsion spring 118. Once assembled, the support 380 is positioned on the first support post 318 (see FIG. 13), and the support 380 extends through the passage 322 in the base 120 (see FIG. 7). As illustrated in FIG. 8, the support 380 comprises a U-shaped body 382 that includes legs 384 that extend therefrom. The U-shaped body 382 of the support 380 further comprises a flange 386 that extends circumferentially around a top of the U-shaped body 382. The legs 384 extend downwardly from the U-shaped body 382 through the passage 322 of the base 120 (see FIG. 7). Further, the legs 384 define feet 388 that are configured to snap onto a bottom side of the base 120 through the passage 322 (see FIG. 7).

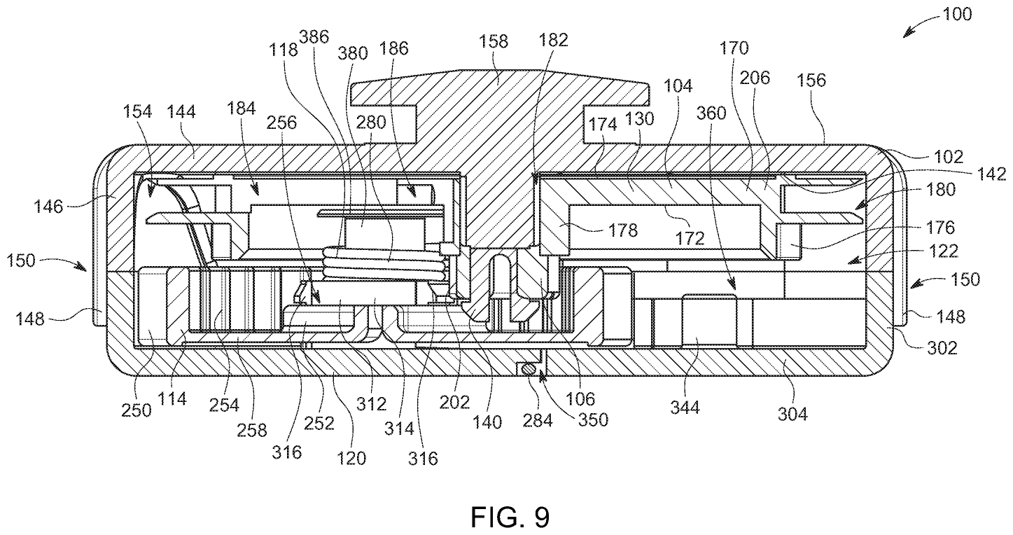

With reference to FIG. 9, a cross-sectional view of the reel damper 100 is shown. As illustrated in FIG. 9, the spool gear 104 is rotatably engaged with the cap 102. In particular, the axle post 140 of the cap 102 is rotatably received in the axle well 182 of the spool gear 104. Further, the support 380 is illustrated extending upwardly from the base 120. In preferred embodiments, the support 380 slidably engages the body 170 of the spool gear 104 to act as a bearing for the spool gear 104. Therefore, when assembled, the spool gear 104 is supported by the support 380 and the axle post 140 of the cap 102. The spool gear 104 is configured to rotate within the interior portion 122 of the reel damper 100.

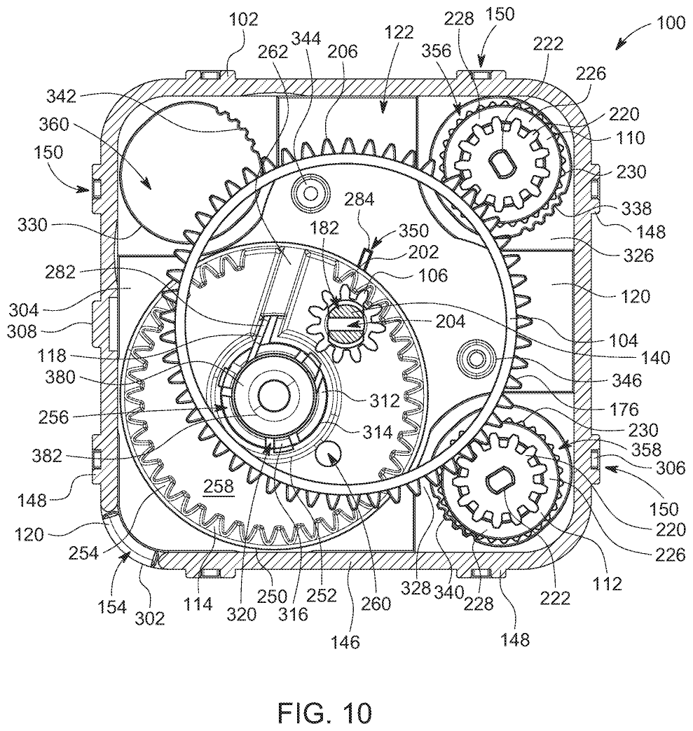

With reference still to FIG. 9, the ring gear 114 is positioned on and rotatably engaged with the base 120. Specifically, the ring gear 114 is snapped onto the axle hub 312 of the base 120. As illustrated in FIG. 9, the plurality of hooks 316 of the axle hub 312 are configured to deflect inwardly to allow the ring gear 114 to be positioned around the axle hub 312 of the base 120. Once the ring gear 114 is fully placed onto the base 120, the plurality of hooks 316 snap back into place over the inner circumferential wall 252 of the ring gear 114. After the plurality of hooks 316 snap onto the ring gear 114, the ring gear 114 is rotatably secured to the base 120. As illustrated in FIG. 10, the ring gear 114 is eccentrically attached to the base 120 of the reel damper 100.

With reference to FIG. 10, another cross-sectional view of the reel damper 100 is shown. As illustrated in FIG. 10, the spool gear 104 is engaged with the first damper assembly 110 and the second damper assembly 112. Therefore, the first set of gear teeth 176 of the spool gear 104 are meshed with the pinions 220 of the first damper assembly 110 and the second damper assembly 112. As such, the first damper assembly 110 and the second damper assembly 112 are able to dampen the rotation of the spool gear 104. As will be discussed in further details herein, the first damper assembly 110 and the second damper assembly 112 are configured to axially move about the first damper well 356 and the second damper well 358, respectively, depending on the rotation of the spool gear 104.

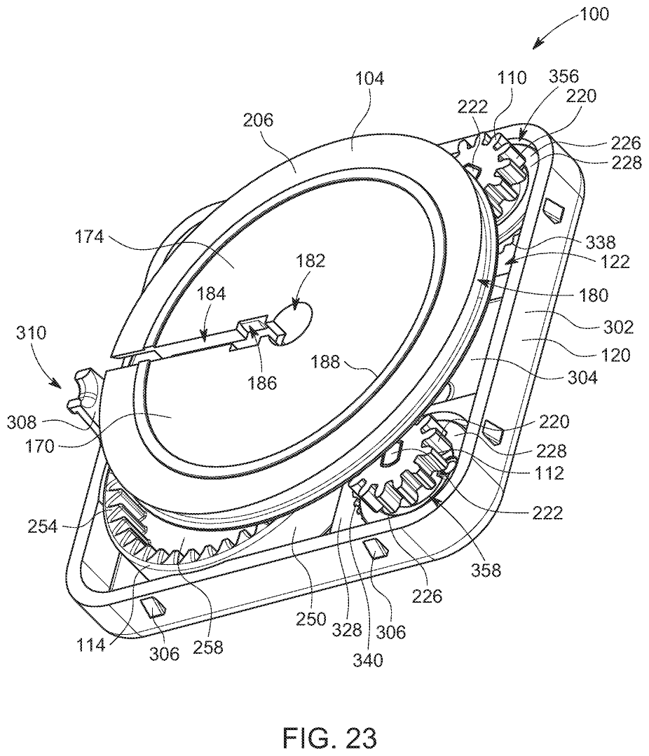

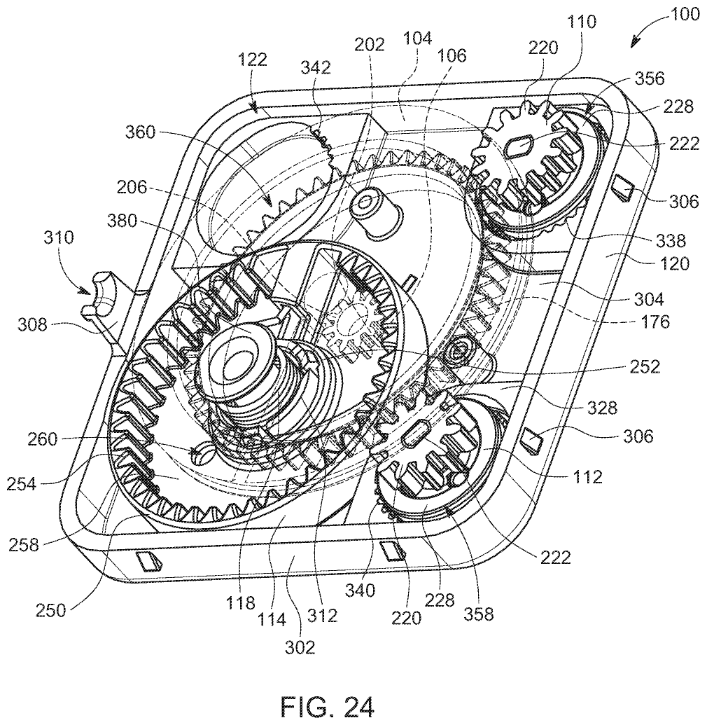

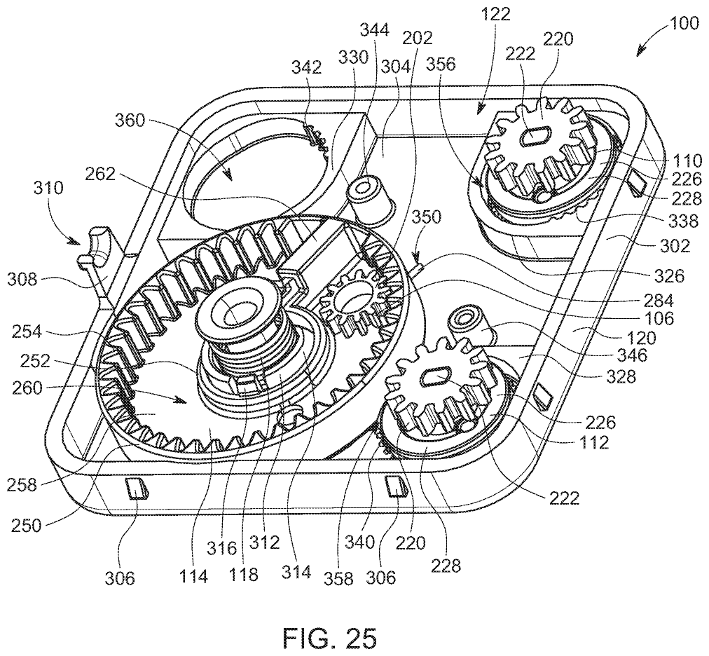

With reference to FIGS. 23 and 24, various views of the reel damper 100 without the cap 102 are shown. As illustrated in FIG. 24, the sun gear 106 is engaged with the ring gear 114. In particular, the second set of gear teeth 202 of the sun gear 106 are meshed with the third set of gear teeth 254 of the ring gear 114. As such, the sun gear 106 is disposed in the ring gear 114 between the outer circumferential wall 250 and the inner circumferential wall 252 (see FIGS. 25 and 26). Therefore, as illustrated in FIG. 24, rotation of the gear assembly 206, i.e., the sun gear 106 and the spool gear 104, drives rotation of the ring gear 114 and vice versa. As discussed above, the third set of gear teeth 254 only extends partially around the ring gear 114. Therefore, the sun gear 106 is only configured to rotate with the ring gear 114 for a certain rotational period.

With reference to FIGS. 25 and 26, various views of the reel damper 100 without the cap 102 and the spool gear 104 are shown. As illustrated in FIGS. 25 and 26, the torsion spring 118 is supported by the first support post 318 (see FIG. 12), the support 380, and/or the axle hub 312. Specifically, the coil portion 280 of the torsion spring 118 is disposed in the axle hub 312 of the base 120 and about the first support post 318 (see FIG. 12) and the support 380. As illustrated in FIG. 26, the second leg 284 of the torsion spring 118 passes through the axle hub 312 via one of the gaps 320 that exists between the plurality of arched walls 314 and the plurality of hooks 316. Further, the second leg 284 of the torsion spring 118 extends underneath the ring gear 114, between the ring gear 114 and the base 120. As discussed above, the second leg 284 of the torsion spring 118 is engaged with the base 120. In particular, the second leg 284 of the torsion spring 118 extends through the spring opening 350 such that the second leg 284 is securely positioned between the bridge 352 (see FIG. 13) and the ribs 354 that extend into the spring opening 350 (see FIG. 7).

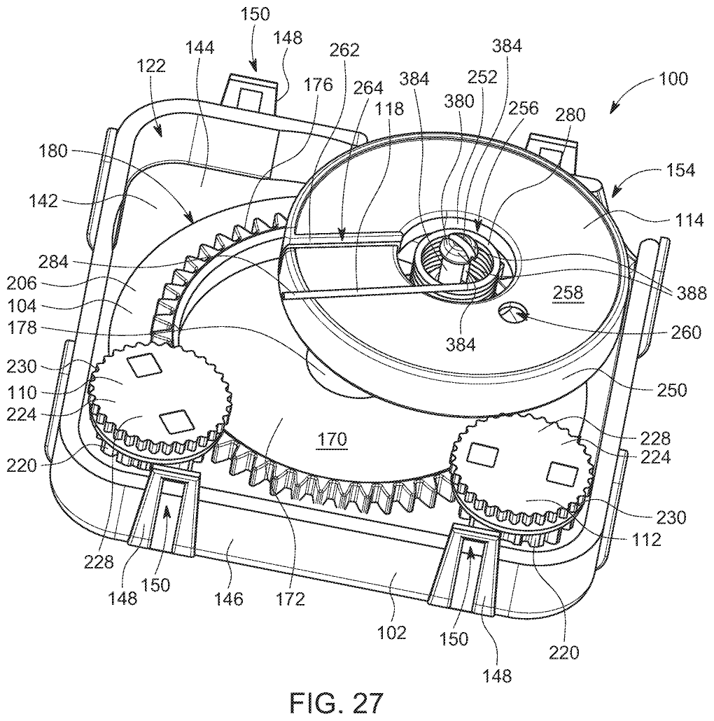

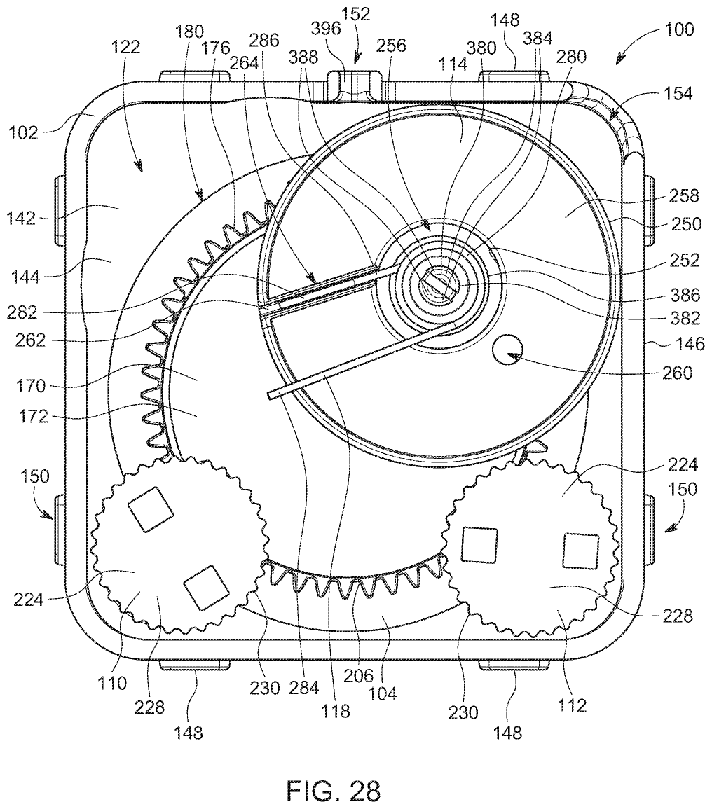

With reference to FIGS. 27-29, various views of the reel damper 100 without the base 120 are shown. As illustrated in FIGS. 26, 28, and 29, the first leg 282 of the torsion spring 118 is engaged with the ring gear 114 via the spring retainer 262. In particular, the first leg 282 of the torsion spring 118 is retained in the spring channel 264 by the spring retainer 262. As such, the torsion spring 118 urges the ring gear 114 to a wound position relative to the base 120 (see FIG. 25) via the first leg 282 being positioned within the spring retainer 262 of the ring gear 114. Put differently, the torsion spring 118 is configured to rotate the ring gear 114.

With reference again to FIG. 26, as discussed above, the first damper assembly 110 is disposed in the first damper well 356, and the second damper assembly 112 is disposed in the second damper well 358. During operation, the ratchet teeth 230 of the first damper assembly 110 selectively engage the first set of pawl teeth 338 of the first retaining wall 326. Further, the ratchet teeth 230 of the second damper assembly 112 also selectively engage the second set of pawl teeth 340 of the second retaining wall 328. It should be appreciated that the third damper assembly discussed above in connection with FIG. 8 may be disposed in the third damper well 360 to selectively engage the third set of pawl teeth 342 of the third retaining wall 330.

With reference still to FIG. 26, movement of the string (not shown) in one direction (the damping direction) causes the first and second damper assemblies 110, 112 to move in the first and second damper wells 156, 158, respectively, toward the first and second set of pawl teeth 338, 340. This causes the ratchet teeth 230 of the first and second damper assemblies 110, 112 to engage the first and second set of pawl teeth 338, 340 to secure the first and second damper assemblies 110, 112 in position. As such, this engagement stops the base 228 of the first and second damper assemblies 110, 112 from rotating. However, since the spool gear 104 and the first and second damper assemblies 110, 112 are meshed (see FIG. 24), the pinion 220 on the first and second damper assemblies 110, 112 will still rotate even though the base 228 of the first and second damper assemblies 110, 112 is secured. Since the rotation of the pinion 220 of the first and second damper assemblies 110, 112 is resistive, the first and second damper assemblies 110, 112 cause a damping effect on the rotation of the spool gear 104 to provide damping control (see FIG. 24). As discussed above, depending on the viscosities used in the first and second damper assemblies 110, 112, the resistance of the first and second damper assemblies 110, 112 may vary.

Conversely, with reference still to FIG. 26, movement of the string (not shown) in an opposite direction causes the first and second damper assemblies 110, 112 to move in the first and second damper wells 356, 358, respectively, away from the first and second set of pawl teeth 338, 340. In this condition, the base 228 of the first and second damper assemblies 110, 112 is no longer fixed in position, and is freely rotatable within the first and second damper wells 356, 358. With the base 228 of the first and second damper assemblies 110, 112 not secured, as the spool gear 104 rotates (see FIG. 24), the entire first and second damper assemblies 110, 112 rotate (including the base 120), thereby eliminating damping action by the first and second damper assemblies 110, 112. As such, the first and second damper assemblies 110, 112 are configured to provide one-way damping for the reel damper 100. In alternative embodiments, the first and second damper assemblies 110, 112 may be configured to provide two-way damping for the reel damper 100. For example, the damping configuration used may be of the type disclosed in U.S. Pat. No. 7,152,718, which is incorporated herein by reference in its entirety.

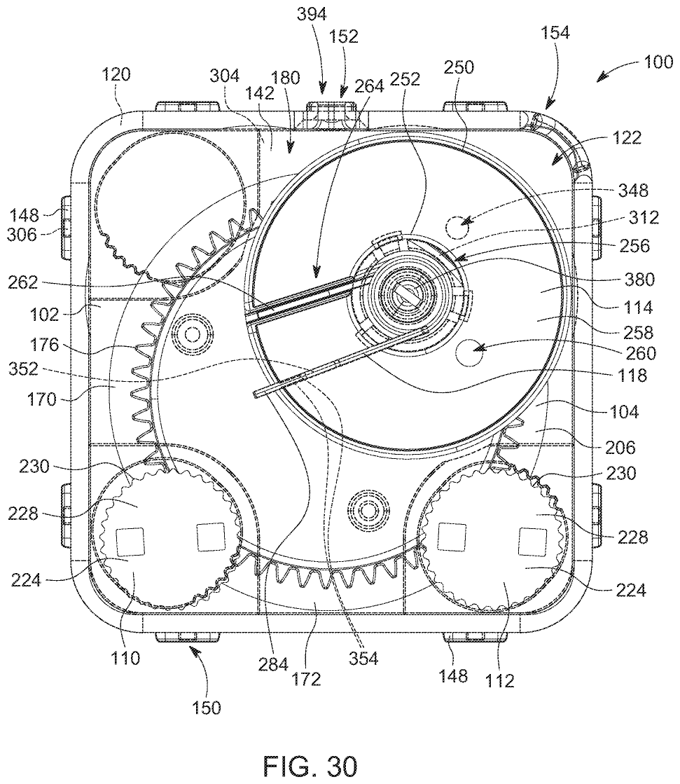

With reference to FIG. 30, a bottom view of the reel damper 100 with the base 120 dashed is shown. As illustrated in FIG. 30, during assembly, the ring gear 114 is rotated about the axle hub 312 to align the first alignment opening 260 of the ring gear 114 with the second alignment opening 348 of the base 120 to pre-load the torsion spring 118. Therefore, the torsion spring 118 is pre-loaded such that the torsion spring 118 is tight when the vehicle hatch, for example, is closed. In one example, a pin (not shown) may be inserted through the first alignment opening 260 of the ring gear 114 and the second alignment opening 348 of the base 120 to hold the torsion spring 118 in a loaded position while the gear assembly 206 is meshed with the ring gear 114, the first damper assembly 110, and the second damper assembly 112. Therefore, during assembly, the ring gear 114 and the torsion spring 118 are first added to the base 120 of the reel damper 100 prior to the gear assembly 206. However, in alternative embodiments, the reel damper 100 may be assembled in any order.

With reference back to FIG. 8, after assembly of the spool gear 104, the sun gear 106, the first damper assembly 110, the second damper assembly 112, the ring gear 114, and the torsion spring 118, the base 120 and the cap 102 of the reel damper 100 are attached to each other. In particular, each tab of the plurality of tabs 306 of the base 120 corresponds to one of the slots 150 of the clips 148. As such, the plurality of tabs 306 snappingly engage the cap 102 via the plurality of slots 150 to join the cap 102 to the base 120 (see FIG. 1). In some embodiments, the cap 102 may be removably secured to the base 120. In other embodiments, the cap 102 can be permanently secured to the base 120. In such an embodiment, the cap 102 may be secured or attached to the base 102 via ultrasonic/laser welding, gluing, or the like. As illustrated in FIG. 5, when the cap 102 and the base 120 are joined, the first string channel 152 is in communication with the second string channel 310. Thus, the cap 102 and the base 120 define a string opening 394. As further illustrated in FIG. 5, the string opening 394 comprises a reinforced outer perimeter 396 that surrounds the string opening 394.

In a typical installation, the reel damper 100 can be attached to any surface or device by various means, including snaps, screws, adhesive, or the like. As discussed above, in one example, the reel damper 100 can be used on glove box doors of automobiles, in which the reel damper 100 is attached to a stationary frame of the glove box. In such an example, the free end of the string (not shown) can be attached to a moveable portion, for example, a glove box door. As noted herein, an example of the reel damper 100 in communication with a glove box door will be discussed. However, in alternative embodiments, the reel damper 100 may be used in various portions of the vehicle.

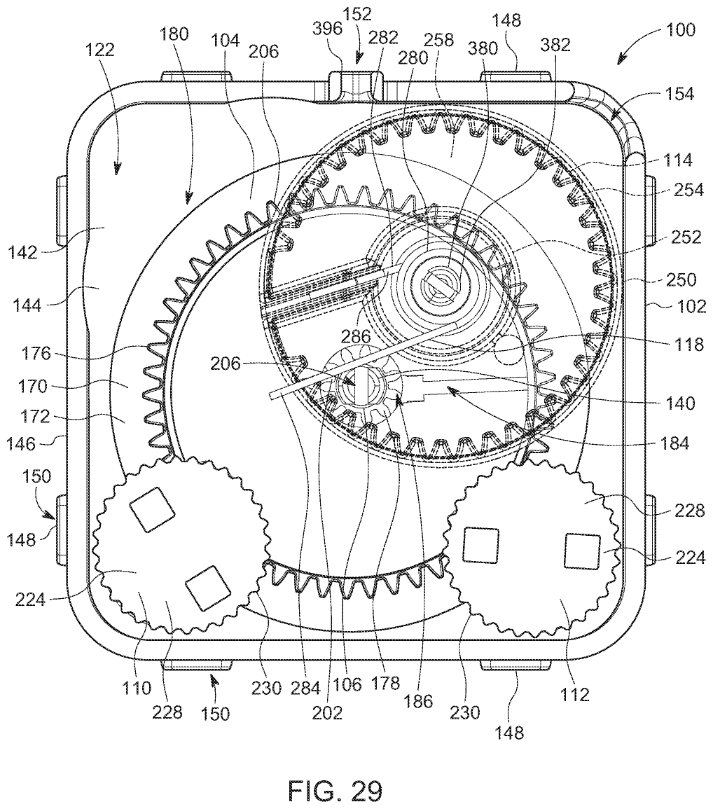

With reference to FIG. 29, as the glove box door is opened, the string (not shown) is pulled outwardly through the string opening 394 (FIG. 5), thus causing the spool gear 104 to rotate. Rotation of the spool gear 104 results in the sun gear 106 rotating the ring gear 114. As the ring gear 114 is rotated, the torsion spring 118 is wound tighter. The combination of the first and second damper assemblies 110, 112 and the torsion spring 118 resistance creates a damped opening movement on the glove box door. When it is desired to close the glove box door, the torsion spring 118 turns the ring gear 114 in the opposite direction, which in turn causes the sun gear 106 and the spool gear 104 to also rotate in the opposite direction. As the spool gear 104 rotates in the opposite direction, the string (not shown) winds back on the reel track 180 of the spool gear 104. In addition to rewinding the string (not shown), the torsion spring 118 force also assists in closing the glove box door. In this example and as discussed above, the torsion spring 118 is pre-loaded such that the torsion spring is tight when the glove box is closed.

As noted herein, in some embodiments, the reel damper 100 may comprise a switch and/or a switch ready feature (not shown) in communication with or attached with one of the first or second damper assemblies 110, 112 and/or the spool gear 104. In such an embodiment, the switch may be attached to the cap 102 or the base 120 of the reel damper 100 and comprise a cam that controls the switch. Therefore, depending on the position of the reel damper 100, the switch may activate to provide an electric current. In one example, the reel damper 100 may activate a light in the glove box when the glove box door is open. In some embodiments, the switch used is of the type disclosed in United States Publication No. 2019/0161019, which is incorporated herein by reference in its entirety.

From the foregoing, it will be appreciated that the reel damper 100 provides damped motion to vehicle hatches. Thus, the reel damper 100 slows opening and closing of a vehicle hatch door relative to a vehicle hatch jamb or other vehicle hatch components. Further, the reel damper 100 operates via the torsion spring 118. Thus, the reel damper 100 may provide a cost-saving approach compared to existing reel dampers.

While various spatial and directional terms, such as top, bottom, lower, mid, lateral, horizontal, vertical, front, and the like may be used to describe embodiments of the present disclosure, it is understood that such terms are merely used with respect to the orientations shown in the drawings. The orientations may be inverted, rotated, or otherwise changed, such that an upper portion is a lower portion, and vice versa, horizontal becomes vertical, and the like.

Variations and modifications of the foregoing are within the scope of the present disclosure. It is understood that the embodiments disclosed and defined herein extend to all alternative combinations of two or more of the individual features mentioned or evident from the text and/or drawings. All of these different combinations constitute various alternative aspects of the present disclosure. The claims are to be construed to include alternative embodiments to the extent permitted by the prior art.

To the extent used in the appended claims, the terms “including” and “in which” are used as the plain-English equivalents of the respective terms “comprising” and “wherein.” Moreover, to the extent used in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

As noted previously, it will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein.

Various features of the disclosure are set forth in the following claims.

We claim:

1. A reel damper, comprising:
a base;
a cap secured to the base;
a ring gear rotatably engaged with the base;
a torsion spring engaged with the base and the ring gear; and
a sun gear disposed in and meshed with the ring gear.

2. The reel damper of claim 1, wherein the reel damper comprises a spool gear attached to the sun gear and rotatably engaged with the cap.

3. The reel damper of claim 2, wherein the spool gear is configured to retain a string around the spool gear.

4. The reel damper of claim 1, wherein the reel damper includes at least one damper assembly.

5. The reel damper of claim 1, wherein the torsion spring comprises a coil portion that is disposed in the base.

6. The reel damper of claim 5, wherein the torsion spring further comprises a first leg and a second leg extending from the coil portion.

7. The reel damper of claim 6, wherein the first leg is substantially straight, and wherein the second leg comprises an angled portion.

8. The reel damper of claim 1, wherein the torsion spring is pre-loaded during assembly.

9. The reel damper of claim 1, wherein the ring gear is eccentrically attached to the base of the reel damper.

10. A reel damper, comprising:
a base;
a cap attached to the base;
a ring gear rotatably engaged with the base;
a torsion spring engaged with the base and the ring gear;
a sun gear disposed in and meshed with the ring gear; and
a spool gear attached to the sun gear and rotatably engaged with the cap, wherein the spool gear comprises a reel track that extends circumferentially around the spool gear.

11. The reel damper of claim 10, wherein the spool gear is meshed with at least one damper assembly.

12. The reel damper of claim 11, wherein the at least one damper assembly comprises a set of ratchet teeth that extend circumferentially around the at least one damper assembly.

13. The reel damper of claim 12, wherein the set of ratchet teeth selectively engage a set of pawl teeth on the base.

14. The reel damper of claim 10, wherein the torsion spring comprises a coil portion, and wherein the torsion spring further comprises a first leg and a second leg extending from the coil portion.

15. The reel damper of claim 14, wherein the first leg of the torsion spring is positioned within a spring retainer of the ring gear.

16. The reel damper of claim 10, wherein the ring gear comprises gear teeth that only partially extend around a circumference of the ring gear.

17. A reel damper for a vehicle, comprising:
a base;
a cap attached to the base;
a ring gear rotatably engaged with the base;
a torsion spring engaged with the base and the ring gear;
a sun gear disposed in and meshed with the ring gear; and
a spool gear attached to the sun gear and rotatably engaged with the cap, wherein the spool gear comprises a set of gear teeth that mesh with at least one damper assembly, and wherein the spool gear further comprises a reel track that extends circumferentially around the spool gear,
wherein the ring gear, the torsion spring, the sun gear, and the spool gear are positioned in an interior portion inside the cap and the base.

18. The reel damper of claim 17, wherein rotation of the spool gear drives rotation of the ring gear.

19. The reel damper of claim 17, wherein the torsion spring is configured to rotate the ring gear.

20. The reel damper of claim 17, wherein the torsion spring comprises a coil portion, and wherein the torsion spring further comprises a first leg and a second leg extending from the coil portion.
